(19) United States
(12) Patent Application Publication
(10) Pub. No.: US 2021/0135501 A1
(43) Pub. Date: May 6, 2021

(54) TRANSMITTER AND METHOD FOR WIRELESS CHARGING, AND TERMINAL

(71) Applicant: BEIJING XIAOMI MOBILE SOFTWARE CO., LTD., Beijing (CN)

(72) Inventors: Yajun PAN, Beijing (CN); Shujun WEI, Beijing (CN); Jian BAI, Beijing (CN)

(73) Assignee: BEIJING XIAOMI MOBILE SOFTWARE CO., LTD., Beijing (CN)

(21) Appl. No.: 16/809,340

(22) Filed: Mar. 4, 2020

(30) Foreign Application Priority Data
Nov. 4, 2019 (CN) 201911067279.4

(51) Int. Cl. H02J 50/20; H02J 7/02; H02J 50/60; H02J 50/00; H02J 50/40; H02J 7/00; H04M 1/02

(52) U.S. Cl. CPC H02J 50/20; H02J 7/02; H02J 50/60; H02J 50/005; H02J 50/80; H02J 7/0047; H02J 7/0042; H04M 1/0202; H02J 2207/20; H02J 50/40

(57) ABSTRACT

Provided are a transmitter and method for wireless charging, and a terminal. The transmitter for wireless charging can include an input circuit, configured to receive a first alternating-current electric signal of a first frequency, a first conversion circuit, configured to convert the first alternating-current electric signal into a second alternating-current electric signal of a second frequency, and at least one first radio frequency antenna, connected with the first conversion circuit and configured to convert the second alternating-current electric signal into a radio frequency signal for wireless charging and transmit the radio frequency signal. Therefore, long-distance wireless charging may be implemented based on a characteristic that the radio frequency transmitted by the transmitter for wireless charging may be transmitted at a long distance and may penetrate a nonmetallic object.

### CROSS-REFERENCE TO RELATED APPLICATION

This application is based upon and claims priority to Chinese patent application No. 201911067279.4 filed on Nov. 04, 2019, the entire contents of which are incorporated herein by reference.

### TECHNICAL FIELD

The present disclosure generally relates to the technical field of wireless charging, and more particularly, to a transmitter for wireless charging, a terminal and a method for wireless charging.

### BACKGROUND

Wireless charging solutions generally include an electromagnetic-induction-based Wireless Power Consortium (WPC) standard and a magnetic resonance technology-based AirFuel Alliance (AFA) standard (which is established by the AirFuel alliance). Both a WPC solution and an AFA solution are technologies applied to short-distance wireless charging of a transmission device and a receiving device within about 5 mm. Along with extension of Internet of everything scenarios, long-distance wireless charging solutions have become more and more important.

### SUMMARY

According to a first aspect of embodiments of the present disclosure, a transmitter for wireless charging is provided that can include an input circuit configured to receive a first alternating-current electric signal of a first frequency, a first conversion circuit configured to convert the first alternating-current electric signal into a second alternating-current electric signal of a second frequency, and at least one first radio frequency antenna that is connected with the first conversion circuit and configured to convert the second alternating-current electric signal into a radio frequency signal for wireless charging and transmit the radio frequency signal.

According to a second aspect of the embodiments of the present disclosure, a terminal is provided that can include at least one second radio frequency antenna, configured to receive a radio frequency signal for wireless charging, a second conversion circuit, connected with the at least one second radio frequency antenna and configured to convert the radio frequency signal into a third direct-current electric signal of a third frequency, and a charging circuit, configured to charge the terminal based on the third direct-current electric signal.

According to a third aspect of the embodiments of the present disclosure, a method for wireless charging is provided, which may be applied to a transmitter for wireless charging, that can include a first alternating-current electric signal of a first frequency is received, the first alternating-current electric signal is converted into a second alternating-current electric signal of a second frequency, and based on at least one first radio frequency antenna on the transmitter for wireless charging, the second alternating-current electric signal is converted into a radio frequency signal for wireless charging, and the radio frequency signal is transmitted.

According to a fourth aspect of the embodiments of the present disclosure, a method for wireless charging is provided, which may be applied to a terminal, that can include a radio frequency signal for wireless charging is received based on at least one second radio frequency antenna, the radio frequency signal is converted into a third direct-current electric signal of a third frequency, and the terminal is charged based on the third direct-current electric signal.

The technical solutions provided by embodiments of the present disclosure can have beneficial effects. For example, the transmitter for wireless charging may convert the first alternating-current electric signal of a low frequency into the second alternating-current electric signal of a high frequency through the first conversion circuit and convert the second alternating-current electric signal into the radio frequency signal through the first radio frequency antenna for radiation to a space around. That is, since the transmitter for wireless charging transmits the radio frequency signal, long-distance wireless signal transmission may be implemented under an obstructed condition based on characteristic that the radio frequency signal is high in frequency and may penetrate an obstruction, such as a nonmetallic object. Therefore, a terminal may receive a radio frequency signal under an obstructed condition and implement long-distance wireless charging based on the radio frequency signal to meet a requirement of a user on long-distance wireless charging.

It should be understood that the above general descriptions and detailed descriptions below are only exemplary and explanatory, and not intended to limit the present disclosure.

### BRIEF DESCRIPTION OF THE DRAWINGS

The accompanying drawings, which are incorporated in and constitute a part of this specification, illustrate exemplary embodiments consistent with the present disclosure and, together with the description, serve to explain the principles of the present disclosure.

FIG. 1 is a typical application scenario of an infrared long-distance wireless charging solution.

FIG. 2 is a schematic diagram illustrating a mobile phone receiving an infrared signal based on an infrared long-distance wireless charging solution.

FIG. 3 is a structure diagram of a transmitter for wireless charging according to an exemplary embodiment.

FIG. 4 is a structure diagram of a transmitter for wireless charging according to an exemplary embodiment.

FIG. 5 is a structure diagram of a transmitter for wireless charging according to an exemplary embodiment.

FIG. 6 is a structure diagram of a transmitter for wireless charging according to an exemplary embodiment.

FIG. 7 is a structure diagram of a transmitter for wireless charging according to an exemplary embodiment of the present disclosure.

FIG. 8 is a structure diagram of a terminal according to an exemplary embodiment.

FIG. 9 is a structure diagram of a terminal according to an exemplary embodiment.

FIG. 10 is a structure diagram of a terminal according to an exemplary embodiment of the present disclosure.

FIG. 11 is a structure diagram of another terminal according to an exemplary embodiment of the present disclosure.

FIG. 12 is a flowchart showing a method for wireless charging according to an exemplary embodiment.

FIG. 13 is a flowchart showing a method for wireless charging according to an exemplary embodiment.

FIG. 14 is a block diagram of a device for wireless charging according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Wireless charging solutions are mostly AFA/WPC-standard-based short-distance wireless charging. For long-distance wireless charging, techniques, such as infrared long-distance wireless charging solutions have been proposed. Based on a characteristic that an infrared signal may be transmitted wirelessly, a solution of converting an infrared ray into electric energy to charge a mobile phone has been proposed.

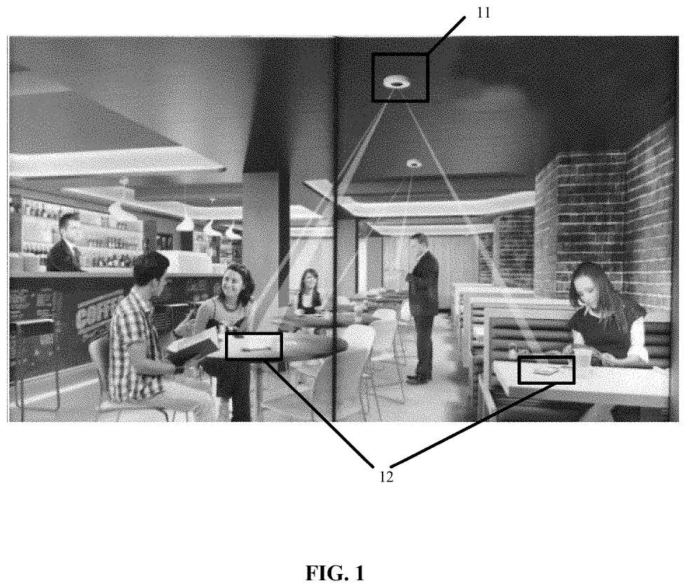

As an example, FIG. 1 is a typical application scenario of an infrared long-distance wireless charging solution. As shown in FIG. 1, devices 11 mounted at a top of a room in FIG. 1 are transmission devices for infrared long-distance wireless charging. Mobile devices 12 placed on square tables and round tables may all be mobile phones. The transmission devices for infrared long-distance wireless charging may transmit infrared signals to implement long-distance wireless charging of the mobile phones placed on multiple tables. However, due to a characteristic that an infrared ray may not penetrate an obstruction for transmission, the infrared long-distance wireless charging solution may only be applied to long-distance wireless charging in unobstructed and non-touch scenarios, and a user experience can be greatly degraded.

In addition, the mobile phone may receive the infrared signal and can be charged only when the infrared signal is converted into electric energy. However, considering the characteristic that an infrared ray may not penetrate an obstruction for transmission, an infrared receiver is required to be arranged at a certain position on a screen of the mobile phone to implement reception of the infrared signal by the mobile phone, which may destroy the design of a full-screen display and influence a screen-to-body ratio of the mobile phone.

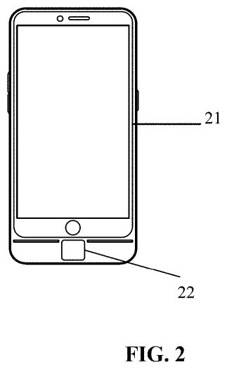

As an example, FIG. 2 is a schematic diagram illustrating a mobile phone receiving an infrared signal based on an infrared long-distance wireless charging solution. As shown in FIG. 2, a device 21 is a mobile phone, and an infrared receiver 22 is arranged over an extended fitting of the mobile phone. For receiving an infrared signal from a transmission device for infrared long-distance wireless charging, the infrared receiver 22 is required to be arranged over the extended fitting of the mobile phone, and then a screen of the mobile phone may not be designed into a full-screen display. Since the infrared receiver 22 is arranged on the screen of the mobile phone, the appearance of the mobile phone may be not so attractive, and a user experience can be degraded.

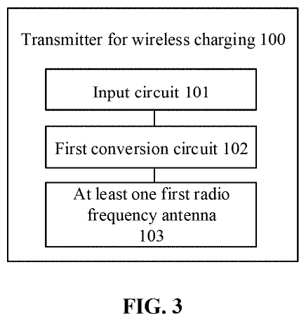

For enabling a user to implement long-distance wireless charging under an obstructed condition, an embodiment of the present disclosure provides a transmitter for wireless charging. FIG. 3 is a structure diagram of a transmitter for wireless charging according to an exemplary embodiment. As shown in FIG. 3, the transmitter for wireless charging 100 includes an input circuit 101, a first conversion circuit 102, and at least one first radio frequency antenna 103.

The input circuit 101 is configured to receive a first alternating-current electric signal of a first frequency. The first conversion circuit 102 is configured to convert the first alternating-current electric signal into a second alternating-current electric signal of a second frequency. The at least one first radio frequency antenna 103 may be connected with the first conversion circuit, and may be configured to convert the second alternating-current electric signal into a radio frequency signal for wireless charging and transmit the radio frequency signal.

During a practical application, the transmitter for wireless charging 100, after accessing an alternating current network, may convert the received alternating-current electric signal into the radio frequency signal for transmission, and then a wireless charging receiver (a wireless charging receiver in a mobile phone), after receiving the radio frequency signal, may convert the radio frequency signal into electric energy capable of charging the mobile phone.

The radio frequency signal may be a high-frequency alternating current electromagnetic wave which has a frequency range from 300 kHz to 300 GHz. Here, an electromagnetic wave with a frequency higher than 100 khz may be propagated in the air and reflected through an ionized layer on an outer edge of the atmosphere, and has a long-distance transmission capability.

A high-frequency electromagnetic wave may also have a capability of penetrating a nonmetallic object due to a high frequency and a small wavelength. Therefore, long-distance wireless charging may be implemented under an obstructed condition. In the embodiment of the present disclosure, the radio frequency signal may be transmitted through the radio frequency antenna to implement obstructed long-distance wireless charging of the mobile phone.

The input circuit 101 may be configured to receive the first alternating-current electric signal of the first frequency from the alternating current network. The electric signal output by the alternating current network may be an alternating current, and the frequency thereof is usually low. For example, the alternating current network may output a 50 Hz sinusoidal alternating current. Therefore, the first frequency may be 50 Hz. The first frequency output by the alternating current network in a different region may also be another value, for example, 60 Hz. A magnitude of the first frequency of the first alternating-current electric signal is not limited in the present disclosure.

The input circuit 101, after receiving the first alternating-current electric signal of the first frequency, may output the first alternating-current electric signal to the first conversion circuit 102. The first conversion circuit 102 may be configured to acquire a high-frequency electric signal, namely converting the first alternating-current electric signal of the first frequency into the second alternating-current electric signal of the second frequency, the second frequency being higher than the first frequency. For example, the second frequency may be a frequency higher than 300 khz.

In such a manner, conversion of the first low-frequency alternating-current electric signal transmitted by the alternating current network into the second high-frequency alternating-current electric signal may be implemented through the input circuit 101 and the first conversion circuit 102.

The first radio frequency antenna 103 may be a directional antenna with directionality or an omnidirectional antenna without directionality. However, for the transmitter for wireless charging in the embodiment of the present disclosure, for charging mobile phones of multiple users in multiple directions, the first radio frequency antenna 103 may be an omnidirectional antenna.

The first radio frequency antenna 103 may be connected with the first conversion circuit 102, and after receiving the second alternating-current electric signal of the second frequency from the first conversion circuit 102, may convert the second alternating-current electric signal into the radio frequency signal for wireless charging and transmit the radio frequency signal. The radio frequency signal for wireless charging may be a high-frequency electromagnetic wave. During the practical application, the first radio frequency antenna 103 may convert the second high-frequency alternating-current electric signal into the high-frequency electromagnetic wave for radiation to a space around.

In the embodiment, the transmitter for wireless charging may convert the first low-frequency alternating-current electric signal into the second high-frequency alternating-current electric signal through the first conversion circuit 102 and convert the second alternating-current electric signal into the radio frequency for radiation to the space around through the first radio frequency antenna 103. Long-distance wireless signal transmission may be implemented under an obstructed condition based on a characteristic that the radio frequency signal is high in frequency. Therefore, a basis is provided for long-distance wireless charging of the mobile phone under the obstructed condition.

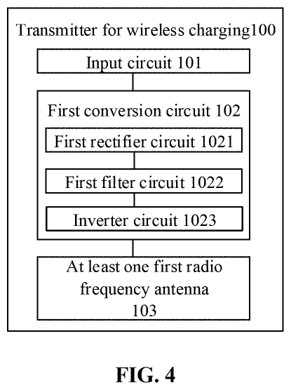

FIG. 4 is a structure diagram of a transmitter for wireless charging according to an exemplary embodiment. As shown in FIG. 4, the first conversion circuit 102 can include a first rectifier circuit 1021, configured to convert the first alternating-current electric signal into a first direct-current electric signal, a first filter circuit 1022, configured to perform smoothing processing on the first direct-current electric signal to obtain a second direct-current electric signal, and an inverter circuit 1023, configured to perform frequency modulation on the second direct-current electric signal to convert the second direct-current electric signal into the second alternating-current electric signal of the second frequency.

In the embodiment, for providing a stable direct-current electric signal for another circuit (for example, a control circuit) in the transmitter for wireless charging 100, the first alternating-current electric signal, transmitted by the alternating current network, of the first frequency may be rectified and filtered through the first rectifier circuit 1021 and the first filter circuit 1022 to obtain the second direct-current electric signal. The second direct-current electric signal may be a flat-waveform direct-current electric signal.

After the flat-waveform direct-current electric signal is obtained, frequency modulation may be performed on the flat-waveform direct-current electric signal through the inverter circuit 1023 to convert the flat-waveform direct-current electric signal into the second high-frequency alternating-current electric signal. Frequency modulation refers to controlling a frequency of a carrier through a modulation signal. The second low-frequency direct-current electric signal may be converted into the second high-frequency alternating-current electric signal by frequency modulation. Therefore, the inverter circuit 1023 may be configured to convert a low-frequency direct current signal into a high-frequency alternating current signal.

In the embodiment, the stable direct-current electric signal may be provided for the transmitter for wireless charging through the first rectifier circuit 1021 and the first filter circuit 1022 for another circuit such as a control circuit to use. Based on this, the high-frequency alternating-current electric signal may be obtained through the inverter circuit 1023. Therefore, the first rectifier circuit 1021, the first filter circuit 1022, and the inverter circuit 1023 may be matched to generate the high-frequency alternating-current electric signal capable of implementing long-distance signal transmission under the obstructed condition on the basis of ensuring basic Work of the transmitter for wireless charging.

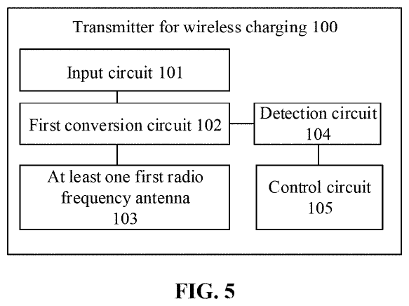

FIG. 5 is a structure diagram of a transmitter for wireless charging according to an exemplary embodiment. As shown in FIG. 5, the transmitter for wireless charging 100 may further include a detection circuit 104, configured to detect whether there is a living body entering a preset range of the transmitter for wireless charging or not and form a detection signal, and a control circuit 105, connected with the detection circuit 104 and configured to, when the detection signal indicates that there is a living body entering the preset range, reduce transmission power of the radio frequency signal.

As shown in FIG. 5, the transmitter for wireless charging 100 may include the input circuit 101, the first conversion circuit 102, the at least one first radio frequency antenna 103, the detection circuit 104, and the control circuit 105.

The detection circuit 104 and the control circuit 105 may be matched to realize a biological detection function. Biological detection refers to detecting whether there is a living body entering a radiation range of the transmitter for wireless charging 100 or not. Here, since the frequency of the radio frequency signal is high and radiation exists and hazards a living body to a certain extent, whether there is a living body entering the preset range of the transmitter for wireless charging 100 or not may be detected through the detection circuit 104.

The detection circuit 104 may be an infrared detection circuit including an infrared detector and may detect an intensity of an infrared ray emitted by a living body through the infrared detector to judge whether there is a living body entering the radiation range of the transmitter for wireless charging 100 or not.

When it is detected that there is a living body entering the radiation range of the transmitter for wireless charging 100, a detection signal may be generated. For example, when it is detected that there is a living body entering, a high-level detection signal may be output, and when there is no living body entering, a low-level detection signal may be output.

The detection circuit 104 may be connected with the control circuit 105, and the detection circuit 104 may transmit the detection signal obtained by real-time detection to the control circuit 105. Therefore, the control circuit 105 may judge whether there is a living body entering the preset range of the transmitter for wireless charging 100 or not according to different detection signals that are received, and when it is determined that there is a living body entering the preset range, may reduce the transmission power of the radio frequency signal transmitted by the transmitter for wireless charging 100. The preset range may be determined according to a radiation range corresponding to present transmission power of the transmitter for wireless charging 100. When the present transmission power of the transmitter for wireless charging 100 is higher, the preset range is larger. The living body may be a person, an animal, and the like.

Reducing the transmission power of the radio frequency signal transmitted by the transmitter for wireless charging 100 specifically refers to reducing the transmission power to meet a safety standard for radiation to a human body. For example, when a safety distance is 2.5 m, the transmission power of the transmitter for wireless charging 100 may be reduced to a range defined by a circle centered on the transmitter for wireless charging 100 and having a radius obtained by subtracting 2.5 m from d. The transmission power of the transmitter for wireless charging 100 may be regulated through the safety distance to meet the radiation range.

In an embodiment, the detection circuit 104 may determine whether there is a living body entering the radiation range of the transmitter for wireless charging 100 or not, and may be further matched with the control circuit 105 to reduce influence of radiation of the transmitter for wireless charging 100 during work to a living body. Therefore, a certain guarantee can be provided for health of the living body on the basis of implementing long-distance signal transmission under the obstructed condition.

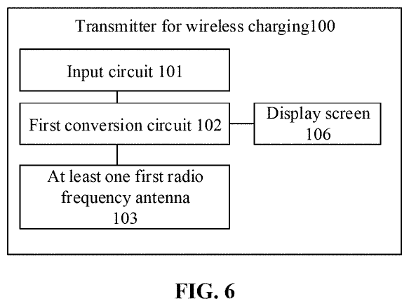

FIG. 6 is a structure diagram of a transmitter for wireless charging according to an exemplary embodiment. As shown in FIG. 6, the transmitter for wireless charging 100 may further include a display screen 106, configured to display a charging parameter for wireless charging, the charging parameter including at least one of: a second frequency; a charging current; a charging voltage; and a charging power.

As shown in FIG. 6, the transmitter for wireless charging 100 may include the input circuit 101, the first conversion circuit 102, the at least one first radio frequency antenna 103 and the display screen 106. On the display screen 106, the abovementioned contents may be displayed, and charging efficiency, a charging duration, and the like may also be displayed.

In the embodiment, each parameter in a charging process may be displayed through the display screen 106. Therefore, a user may directly know about each parameter in the charging process to regulate and control each parameter in the wireless charging process according to the displayed charging parameter, and the user experience is further improved.

It is to be noted that the transmitter for wireless charging may further include a power circuit, and the power circuit can be configured to provide working power for the transmitter for wireless charging.

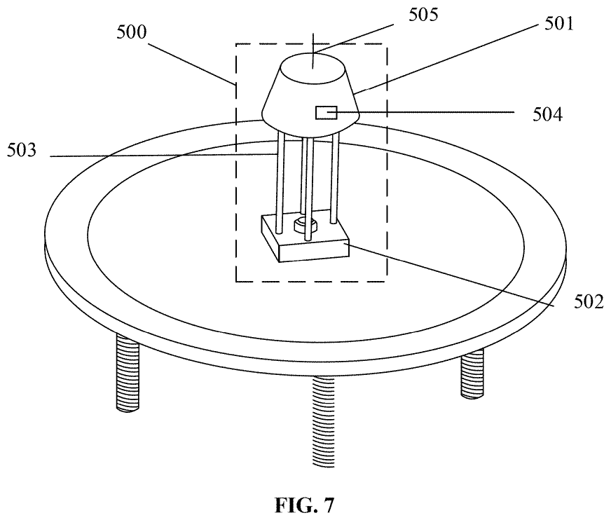

FIG. 7 is a structure diagram of a transmitter for wireless charging according to an embodiment of the present disclosure. As shown in FIG. 7, the transmitter for wireless charging may be designed to have a desk-lamp like shape, and the transmitter for wireless charging of the desk-lamp like shape may be placed on an indoor office table to charge mobile phones supporting long-distance wireless radio frequency charging around.

It is to be noted that the transmitter for wireless charging may also be designed into numerous other shapes, for example, a column and a tower. It should be understood that the shape of the transmitter for wireless charging is not limited in the embodiments of the present disclosure.

As shown in FIG. 7, the transmitter for wireless charging 500 can include a carrier 501, the display screen 504 and the at least one first radio frequency antenna 505 being placed on an outer surface of the carrier 501, a base 502, provided with an accommodation cavity, the input circuit and the first conversion circuit being arranged in the accommodation cavity, and support rods 503, one end of each support rod 503 being connected with the base 502 and the other end being connected with the carrier 501, to support the carrier 501.

In the embodiment of the present disclosure, the carrier 501 may be umbrella-shaped, and the at least one first radio frequency antenna 505 is arranged at a top end of the umbrella-shaped carrier 501. Here, the carrier 501 may also be of other shapes, for example, a cone and a square. It should be understood that the shape of the carrier 501 is also not limited in the embodiments of the present disclosure.

In the transmitter for wireless charging of a desk-lamp like shape in FIG. 7, both the input circuit and the first conversion circuit are arranged in the accommodation cavity of the base 502. Other circuits such as a power circuit and a control circuit, other than components such as the display screen 504 and the at least one first radio frequency antenna 505, may also be arranged in the accommodation cavity of the base 502.

In the embodiment, the transmitter for wireless charging 500 is designed to include the carrier 501, the base 502, and the support rods 503, where the support rods 503 are placed on the base 502 and the carrier 501 is supported by the support rods 503. Therefore, a radiation height of the at least one first radio frequency antenna 505 on the carrier 501 is greater, and the radiation range is larger. Further, the display screen 504 on the carrier 501 may also be at a position opposite to eyes of a human body, which is more favorable for viewing data displayed on the display screen 504 with eyes. Therefore, the wireless charging solution may be optimized, and meanwhile, convenience is brought to the user.

It is to be noted that the transmitter for wireless charging 500 may further include a light emitting component, arranged in the umbrella-shaped carrier 501 and configured to emit light. In an example, the light emitting component may be a Light Emitting Diode (LED) lamp. The types of the light emitting component are not limited in the embodiment of the present disclosure. In such case, since the transmitter for wireless charging is designed to have a desk-lamp like shape and is placed on a desk, a basic function of a desk lamp may be realized based on the light emitting component on the basis of providing the radio frequency signal for wireless charging by the transmitter for wireless charging, and the mobile phone may be charged through the transmitter for wireless charging during study and work.

An embodiment also provides a terminal. The terminal may receive a radio frequency signal and convert the radio frequency signal into a direct-current electric signal for charging to implement charging. Reception of the radio frequency signal may be implemented directly through an antenna, and a wireless charging receiver is not required to be arranged on a screen, so that the terminal may implement long-distance wireless charging under an obstructed condition on the basis of no influence on a screen-to-body ratio of the screen.

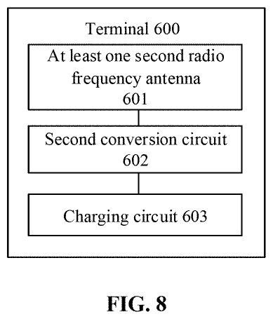

FIG. 8 is a structure diagram of a terminal according to an exemplary embodiment. As shown in FIG. 8, the terminal 600 can include at least one second radio frequency antenna 601, configured to receive a radio frequency signal for wireless charging, a second conversion circuit 602, connected with the at least one second radio frequency antenna 601 and configured to convert the radio frequency signal into a third direct-current electric signal of a third frequency, and a charging circuit 603, configured to charge the terminal 600 based on the third direct-current electric signal.

In the embodiment, the terminal may be an electronic device, such as a mobile phone, a scanner, and a printer. A type of the terminal is not limited in the embodiments.

The at least one second radio frequency antenna 601 may be presented in form of an antenna array. A size and direction of a radiation field may be changed in form of the antenna array. The radiation field is a range of electromagnetic radiation generated by the radio frequency signal generated by the transmitter for wireless charging in the abovementioned embodiments.

Since the antenna array is formed by arranging two or more than two single antennae working at the same frequency according to a certain requirement, unlike a single antenna that is limited in transmission direction, the antenna array formed by arranging multiple single antennae may change the size and direction of the radiation field to further maximally receive the radio frequency signal.

The radio frequency signal received by the at least one second radio frequency antenna 601 may be the radio frequency signal transmitted by the transmitter for wireless charging in the abovementioned embodiments. After the radio frequency signal is received, the radio frequency signal may be transmitted to the second conversion circuit 602. The radio frequency signal may be converted into the third direct-current electric signal of the third frequency through the second conversion circuit 602.

The third direct-current electric signal of the third frequency may be configured to charge the terminal, and may be a frequency-fixed direct current signal. For example, for a power grid in China, the third direct-current electric signal, charging the terminal, of the third frequency may be a 50 HZ direct-current electric signal, which is a low-frequency direct-current electric signal.

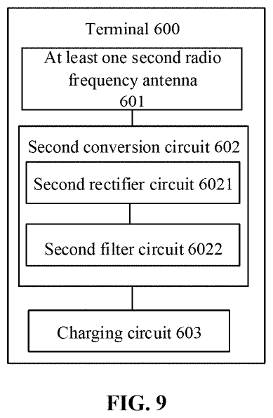

FIG. 9 is a structure diagram of a terminal according to an exemplary embodiment. As shown in FIG. 9, the second conversion circuit 602 can include a second rectifier circuit 6021, configured to convert the radio frequency signal into a fourth direct-current electric signal, and a second filter circuit 6022, configured to perform smoothing processing on the fourth direct-current electric signal to obtain the third direct-current electric signal of the third frequency.

In the embodiment of the present disclosure, since the radio frequency signal is a high-frequency alternating-current electric signal, the second rectifier circuit 6021 and the second filter circuit 6022 are introduced for implementing conversion of the high-frequency radio frequency signal into the third low-frequency direct-current electric signal. The radio frequency signal may be converted into a direct-current electric signal, i.e., the fourth direct-current electric signal, through the second rectifier circuit 6021, and then smoothing processing may be performed on the fourth direct-current electric signal through the second filter circuit 6022 to obtain a flat-waveform direct-current electric signal or a voltage-stable direct-current electric signal, i.e., the third direct-current electric signal of the third frequency. Therefore, the terminal 600 may be charged based on the third voltage-stable direct-current electric signal of the third frequency, and damage to a battery of the terminal 600 may be reduced.

In the embodiment, the radio frequency signal may be received through the at least one second radio frequency antenna 601, and the high-frequency alternating current radio frequency signal may be further converted into the third low-frequency direct-current electric signal through the second conversion circuit 602 to charge the terminal based on the third direct-current electric signal. The terminal 600 may receive the radio frequency signal at a position relatively far from the transmitter for wireless charging based on a characteristic that the radio frequency signal is high in frequency and may penetrate a nonmetallic object to implement radio frequency signal-based long-distance wireless charging, and convenience may be brought to a user.

Specific implementation of the terminal will be described below.

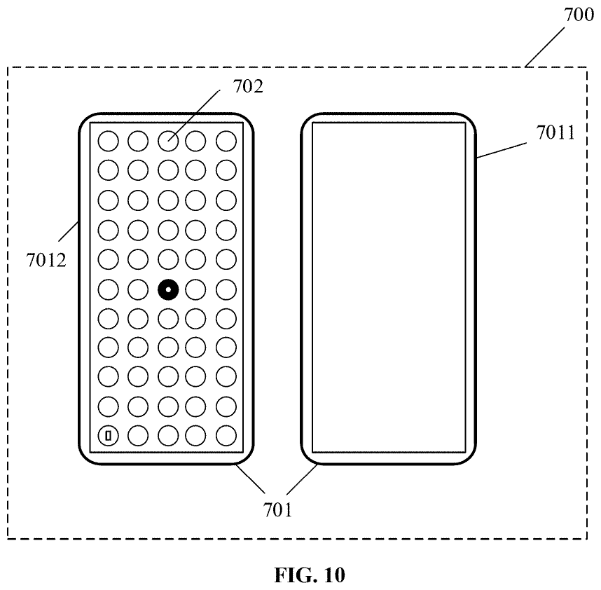

FIG. 10 is a structure diagram of a terminal according to an exemplary embodiment of the present disclosure. As shown in FIG. 10, the terminal may implement long-distance wireless charging under an obstructed condition on the basis of no influence on a screen-to-body ratio of a screen.

The terminal 700 can include a first housing 701, including a first outer surface 7012 and a first inner surface 7011, and at least one second radio frequency antenna 702 that is arranged on the first outer surface 7012. In an example, the terminal 700 may be a mobile phone. For avoiding influence on the screen-to-body ratio of the screen of the mobile phone, the at least one second radio frequency antenna 702 may be arranged on the first outer surface 7012 of the first housing 701 of the mobile phone. The at least one second radio frequency antenna 702 may be arranged in form of an antenna array. Therefore, the size and direction of the radiation field may be changed in form of the antenna array to maximally receive the radio frequency signal.

It is to be noted that the radio frequency signal may penetrate objects made from most of materials but a metallic object may affect reception of the radio frequency signal due to existence of electrostatic screening of the metallic object. Based on this, considering a material of the first housing 701, the at least one second radio frequency antenna 702 may be directly arranged on the first outer surface 7012 of the first housing 701. Therefore, the first housing 701 of the terminal may be made from any material without influence on reception of the radio frequency signal.

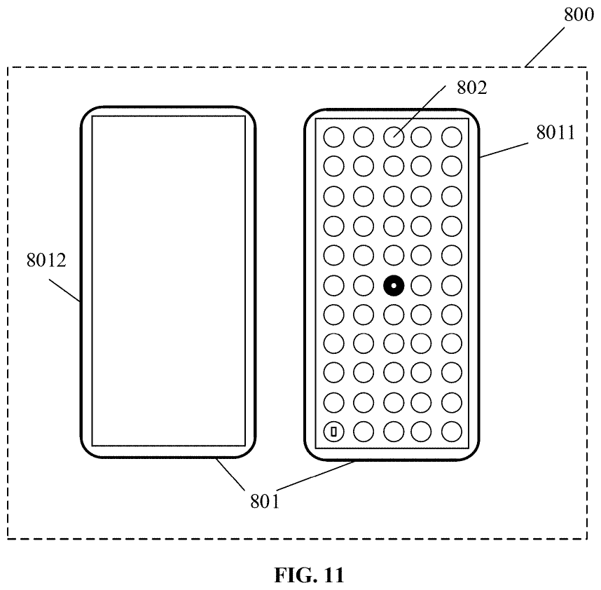

FIG. 11 is a structure diagram of another terminal according to an embodiment of the present disclosure. The terminal 800 can include a second housing 801, including a second outer surface 8012 and a second inner surface 8011, the second housing 801 being made from a nonmetallic material, and at least one second radio frequency antenna 802 that is arranged on the second inner surface 8011.

In an example, considering influence of a metallic shell on the radio frequency signal, the second housing 801 of the terminal may be made from the nonmetallic material that may not affect transmission and reception of the radio frequency signal. The nonmetallic material may be plastics, a composite material, and the like. When the second housing 801 of the terminal is made from the nonmetallic material, the at least one second radio frequency antenna 802 may also be arranged on the second inner surface 8011 of the second housing 801.

In an example, the at least one second radio frequency antenna may be arranged on an outer surface of a housing of the terminal (or on an inner surface of the housing when the housing is made from a nonmetallic material) to receive the radio frequency signal, the high-frequency alternating current radio frequency signal may be converted into the third low-frequency direct-current electric signal through the second conversion circuit on the basis of no influence on the screen-to-body ratio of the screen of the terminal, and the terminal may further be charged based on the third direct-current electric signal. Therefore, the terminal may receive the radio frequency signal at a position relatively far from the transmitter for wireless charging based on the characteristic that the radio frequency signal is high in frequency and may penetrate a nonmetallic object to implement radio frequency signal-based long-distance wireless charging, and convenience may be brought to the user.

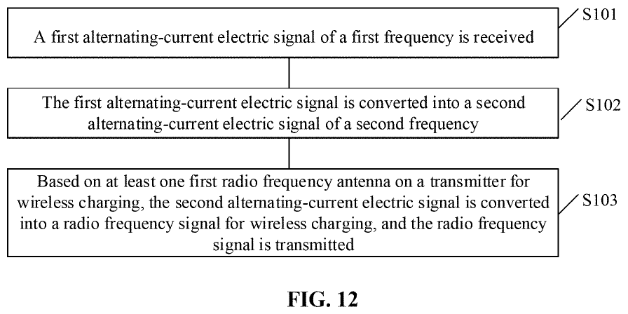

FIG. 12 is a flowchart showing a method for wireless charging according to an exemplary embodiment. The charging method is applied to a transmitter for wireless charging. As shown in FIG. 12, the method for wireless charging can include the following steps.

In S101, a first alternating-current electric signal of a first frequency is received.

In S102, the first alternating-current electric signal is converted into a second alternating-current electric signal of a second frequency.

In S103, based on at least one first radio frequency antenna on the transmitter for wireless charging, the second alternating-current electric signal is converted into a radio frequency signal for wireless charging, and the radio frequency signal is transmitted.

In the embodiment, the method for wireless charging may be applied to the transmitter for wireless charging. The transmitter for wireless charging may include an input circuit, a first conversion circuit and the at least one first radio frequency antenna. The operation in S101 that the first alternating-current electric signal of the first frequency is received may be specifically implemented by the input circuit. The operation in S102 that the first alternating-current electric signal is converted into the second alternating-current electric signal of the second frequency may be specifically implemented by the first conversion circuit.

Therefore, the method for wireless charging applied to the transmitter for wireless charging can include receiving the first alternating-current electric signal of the first frequency through the input circuit, converting the first alternating-current electric signal into the second alternating-current electric signal of the second frequency through the first conversion circuit, and based on the at least one first radio frequency antenna on the transmitter for wireless charging, converting the second alternating-current electric signal into the radio frequency signal for wireless charging, and transmitting the radio frequency signal.

The operation in S102 that the first alternating-current electric signal is converted into the second alternating-current electric signal of the second frequency may further include that the first alternating-current electric signal is converted into a first direct-current electric signal, smoothing processing is performed on the first direct-current electric signal to obtain a second direct-current electric signal, and frequency modulation is performed on the second direct-current electric signal to convert it into the second alternating-current electric signal of the second frequency.

The first low-frequency alternating-current electric signal may be converted into the second high-frequency alternating-current electric signal, and the second alternating-current electric signal may be converted into the radio frequency for radiation to a space around through the first radio frequency antenna on the transmitter for wireless charging. Long-distance wireless signal transmission may be implemented under an obstructed condition based on a characteristic that the radio frequency signal is high in frequency and may penetrate a nonmetallic object. Therefore, a basis is provided for long-distance wireless charging under an obstructed condition.

The first conversion circuit in the transmitter for wireless charging may include a first rectifier circuit, a first filter circuit and an inverter circuit. The operation that the first alternating-current electric signal is converted into the first direct-current electric signal may be specifically implemented by the first rectifier circuit. The operation that smoothing processing is performed on the first direct-current electric signal to obtain the second direct-current electric signal may be specifically implemented by the first filter circuit. The operation that frequency modulation is performed on the second direct-current electric signal to convert it into the second alternating-current electric signal of the second frequency may be specifically implemented by the inverter circuit.

Therefore, the operation in S102 that the first alternating-current electric signal is converted into the second alternating-current electric signal of the second frequency may include that the first alternating-current electric signal is converted into the first direct-current electric signal through the first rectifier circuit, smoothing processing is performed on the first direct-current electric signal to obtain the second direct-current electric signal through the first filter circuit, and frequency modulation is performed on the second direct-current electric signal to convert it into the second alternating-current electric signal of the second frequency through the inverter circuit.

The method may further include forming a detection signal based on whether there is a living body entering a preset range of the transmitter for wireless charging is detected or not, and when the detection signal indicates that there is a living body entering the preset range, transmission power of the radio frequency signal is reduced.

The transmitter for wireless charging may further include a detection circuit and a control circuit. The operation that whether there is a living body entering the preset range of the transmitter for wireless charging or not is detected and the detection signal is formed may be specifically implemented by the detection circuit. The operation that the transmission power of the radio frequency signal is reduced when the detection signal indicates that there is a living body entering the preset range may be specifically implemented by the control circuit.

Therefore, the method may further include forming a detection signal through the detection circuit, whether there is a living body entering the preset range of the transmitter for wireless charging is detected or not, and when the detection signal indicates that there is a living body entering the preset range, the transmission power of the radio frequency signal is reduced through the control circuit.

In the embodiment, whether there is a living body entering the radiation range of the transmitter for wireless charging or not may be determined to reduce influence of radiation of the transmitter for wireless charging during work to a living body. Therefore, a certain guarantee can be provided for health of the living body on the basis of implementing long-distance signal transmission under the obstructed condition.

The method may further include that a charging parameter for wireless charging is displayed through a display screen on the transmitter for wireless charging, the charging parameter including at least one of: the second frequency; a charging current; a charging voltage; and a charging power.

In the embodiment, each parameter in a charging process may be displayed, so that a user may directly know about each parameter in the charging process, and a user experience is further improved.

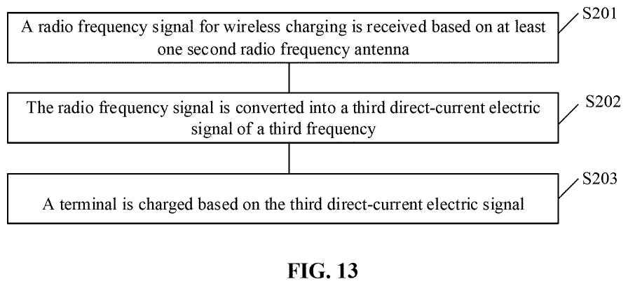

FIG. 13 is a flowchart showing a method for wireless charging according to an exemplary embodiment. The method is applied to a terminal. As shown in FIG. 13, the method for wireless charging includes the following steps.

In S201, a radio frequency signal for wireless charging is received based on at least one second radio frequency antenna.

In S202, the radio frequency signal is converted into a third direct-current electric signal of a third frequency.

In S203, the terminal is charged based on the third direct-current electric signal.

In the embodiment, the method for wireless charging may be applied to the terminal. The terminal may include the at least one second radio frequency antenna, a second conversion circuit and a charging circuit. The second conversion circuit may be connected with the at least one second radio frequency antenna. In S201, the radio frequency signal for wireless charging may be received by the at least one second radio frequency antenna. The operation in S202 that the radio frequency signal is converted into the third direct-current electric signal of the third frequency may be specifically implemented by the second conversion circuit. The operation in S203 that the terminal is charged based on the third direct-current electric signal may be specifically implemented by the charging circuit.

Therefore, the method for wireless charging applied to the terminal may include receiving the radio frequency signal for wireless charging based on the at least one second radio frequency antenna, converting the radio frequency signal into the third direct-current electric signal of the third frequency through the second conversion circuit, and charging the terminal based on the third direct-current electric signal through the charging circuit.

The operation in S202 that the radio frequency signal is converted into the third direct-current electric signal of the third frequency may include that the radio frequency signal is converted into a fourth direct-current electric signal, and a smoothing processing is performed on the fourth direct-current electric signal to obtain the third direct-current electric signal of the third frequency.

The second conversion circuit in the terminal may include a second rectifier circuit and a second filter circuit. The operation that the radio frequency signal is converted into the fourth direct-current electric signal may be specifically implemented by the second rectifier circuit. The operation that smoothing processing is performed on the fourth direct-current electric signal to obtain the third direct-current electric signal of the third frequency may be specifically implemented by the second filter circuit.

Therefore, the operation in S202 that the radio frequency signal is converted into the third direct-current electric signal of the third frequency may include that the radio frequency signal is converted into the fourth direct-current electric signal based on the second rectifier circuit, and a smoothing processing is performed on the fourth direct-current electric signal to obtain the third direct-current electric signal of the third frequency based on the second filter circuit.

In the embodiment, the radio frequency signal may be received through the at least one second radio frequency antenna, and the high-frequency alternating current radio frequency signal may be further converted into the third low-frequency direct-current electric signal to charge the terminal based on the third direct-current electric signal. The radio frequency signal may be received at a position relatively far from a transmitter for wireless charging based on a characteristic that the radio frequency signal is high in frequency to implement radio frequency signal-based long-distance wireless charging, and convenience is brought to a user.

With respect to the method in the above embodiments, specific implementation modes of each step therein have been described in detail in the embodiments regarding the device, which will not be elaborated herein.

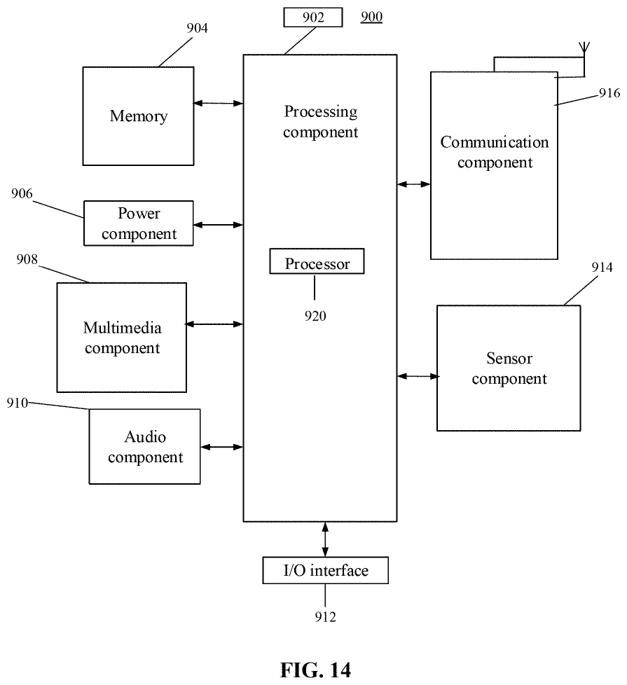

FIG. 14 is a block diagram of a device for wireless charging 900 according to an exemplary embodiment. For example, the device 900 may be a mobile phone, a computer, a digital broadcast terminal, a messaging device, a gaming console, a tablet, a medical device, exercise equipment, a personal digital assistant, and the like.

Referring to FIG. 14, the device 900 may include one or more of the following components: a processing component 902, a memory 904, a power component 906, a multimedia component 908, an audio component 910, an Input/Output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 920 to execute instructions to perform all or part of the steps in the abovementioned method. Moreover, the processing component 902 may include one or more modules which facilitate interaction between the processing component 902 and the other components. For instance, the processing component 902 may include a multimedia module to facilitate interaction between the multimedia component 908 and the processing component 902. The memory 904 is configured to store various types of data to support the operation of the device 900. Examples of such data include instructions for any application programs or methods operated on the device 900, contact data, phonebook data, messages, pictures, video, etc. The memory 904 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 906 is configured to provide power for various components of the device 900. The power component 906 may include a power management system, one or more power supplies, and other components associated with generation, management and distribution of power for the device 900.

In some embodiments, the power component 906 may further include a transmitter for wireless charging, and the power component 906 supplies power to another device through the transmitter for wireless charging.

The multimedia component 908 may include a screen providing an output interface between the device 900 and a user. In some embodiments, the screen may include a Liquid. Crystal Display (LCD) and a Touch Panel (TP). If the screen includes the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 908 may include a front camera and/or a rear camera. The front camera and/or the rear camera may receive external multimedia data when the device 900 is in an operation mode, such as a photographing mode or a video mode. Each of the front camera and the rear camera may be a fixed optical lens system or have focusing and optical zooming capabilities.

The audio component 910 is configured to output and/or input an audio signal. For example, the audio component 910 includes a Microphone (MIC), and the MIC is configured to receive an external audio signal when the device 900 is in the operation mode, such as a call mode, a recording mode and a voice recognition mode. The received audio signal may further be stored in the memory 904 or sent through the communication component 916. In some embodiments, the audio component 910 further includes a speaker configured to output the audio signal.

The I/O interface 912 may provide an interface between the processing component 902 and a peripheral interface module, and the peripheral interface module may be a keyboard, a click wheel, a button and the like. The button may include, but not limited to: a home button, a volume button, a starting button and a locking button.

The sensor component 914 may include one or more sensors configured to provide status assessment in various aspects for the device 900. For instance, the sensor component 914 may detect an on/off status of the device 900 and relative positioning of components, such as a display and small keyboard of the device 900, and the sensor component 914 may further detect a change in a position of the device 900 or a component of the device 900, presence or absence of contact between the user and the device 900, orientation or acceleration/deceleration of the device 900 and a change in temperature of the device 900. The sensor component 914 may include a proximity sensor configured to detect presence of an object nearby without any physical contact. The sensor component 914 may also include a light sensor, such as a Complementary Metal Oxide Semiconductor (CMOS) or Charge Coupled Device (CCD) image sensor, configured for use in an imaging application. In some embodiments, the sensor component 914 may also include an acceleration sensor, a gyroscope sensor, a magnetic sensor, a pressure sensor or a temperature sensor.

The communication component 916 is configured to facilitate wired or wireless communication between the device 900 and other equipment.

The device 900 may access a communication-standard-based wireless network, such as a Wireless Fidelity (WiFi) network, a 2nd-Generation (2G) or 3rd-Generation (3G) network or a combination thereof. In an exemplary embodiment, the communication component 916 may receive a broadcast signal or broadcast associated information from an external broadcast management system through a broadcast channel. In an exemplary embodiment, the communication component 916 may further include a Near Field Communication (NFC) module to facilitate short-range communication. For example, the NFC module may be implemented based on a Radio Frequency Identification (RFID) technology, an Infrared Data Association (IrDA) technology, an Ultra-WideBand (UWB) technology, a Bluetooth (BT) technology and another technology.

In an exemplary embodiment, the device 900 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components.

In an exemplary embodiment, there is also provided a non-transitory computer-readable storage medium including instructions, such as the memory 904 including instructions, and the instructions may be executed by the processor 920 of the device 900 to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, instructions in the storage medium may be executed by a transmitter for wireless charging to enable the transmitter for wireless charging to execute a method for wireless charging, the method including:

receiving a first alternating-current electric signal of a first frequency;

converting the first alternating-current electric signal into a second alternating-current electric signal of a second frequency; and

based on at least one first radio frequency antenna on the transmitter for wireless charging, converting the second alternating-current electric signal into a radio frequency signal for wireless charging, and transmitting the radio frequency signal.

Or, the instruction in the storage medium may be executed by a terminal to enable the terminal to execute a method for wireless charging, the method further including:

receiving a radio frequency signal for wireless charging based on at least one second radio frequency antenna;

converting the radio frequency signal into a third direct-current electric signal of a third frequency; and

charging the terminal based on the third direct-current electric signal.

Other implementation solutions of the present disclosure will be apparent to those skilled in the art from consideration of the specification and practice of the present disclosure. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes may be made without departing from the scope thereof It is intended that the scope of the present disclosure only be limited by the appended claims.

What is claimed is:

1. A transmitter for wireless charging, comprising:
an input circuit that is configured to receive a first alternating-current electric signal of a first frequency;
a first conversion circuit that is configured to convert the first alternating-current electric signal into a second alternating-current electric signal of a second frequency; and
at least one first radio frequency antenna that is coupled with the first conversion circuit and configured to convert the second alternating-current electric signal into a radio frequency signal for wireless charging and transmit the radio frequency signal.

2. The transmitter for wireless charging of claim 1, the first conversion circuit further comprising:
a first rectifier circuit that is configured to convert the first alternating-current electric signal into a first direct-current electric signal;
a first filter circuit that is configured to perform smoothing processing on the first direct-current electric signal to obtain a second direct-current electric signal; and
an inverter circuit that is configured to perform frequency modulation on the second direct-current electric signal to convert the second direct-current electric signal into the second alternating-current electric signal of the second frequency.

3. The transmitter for wireless charging of claim 1, further comprising:
a detection circuit that is configured to detect whether there is a living body entering a preset range of the transmitter for wireless charging and form a detection signal; and
a control circuit that is coupled with the detection circuit and configured to, when the detection signal indicates that there is a living body entering the preset range, reduce transmission power of the radio frequency signal.

4. The transmitter for wireless charging of claim 1, further comprising:
a display screen that is configured to display a charging parameter for wireless charging, the charging parameter comprising at least one of:
the second frequency;
a charging current;
a charging voltage; and
charging power.

5. The transmitter for wireless charging of claim 4, further comprising:
a carrier having an outer surface where the display screen and the at least one first radio frequency antenna are arranged;
a base having an accommodation cavity where the input circuit and the first conversion circuit are arranged therein; and
a support rod, one end of the support rod being connected with the base and the other end being connected with the carrier, to support the carrier.

6. The transmitter for wireless charging of claim 5, wherein
the carrier is umbrella-shaped, and the at least one first radio frequency antenna is arranged at a top end of the umbrella-shaped carrier.

7. The transmitter for wireless charging of claim 5, further comprising:
a light emitting component that is arranged in the carrier of an umbrella shape and configured to emit light.

8. A terminal, comprising:
at least one second radio frequency antenna that is configured to receive a radio frequency signal for wireless charging;
a second conversion circuit that is coupled with the at least one second radio frequency antenna and configured to convert the radio frequency signal into a third direct-current electric signal of a third frequency; and
a charging circuit that is configured to charge the terminal based on the third direct-current electric signal.

9. The terminal of claim 8, wherein the second conversion circuit comprises:
a second rectifier circuit that is configured to convert the radio frequency signal into a fourth direct-current electric signal; and
a second filter circuit that is configured to perform smoothing processing on the fourth direct-current electric signal to obtain the third direct-current electric signal of the third frequency.

10. The terminal of claim 8, further comprising:
a first housing having a first outer surface and a first inner surface,
wherein the at least one second radio frequency antenna is arranged on the first outer surface.

11. The terminal of claim 8, further comprising:
a second housing having a second outer surface and a second inner surface, the second housing being made from a nonmetallic material,
wherein the at least one second radio frequency antenna is arranged on the second inner surface.

12. A method for wireless charging, applied to a transmitter for wireless charging, the method comprising:
receiving a first alternating-current electric signal of a first frequency;
converting the first alternating-current electric signal into a second alternating-current electric signal of a second frequency; and
based on at least one first radio frequency antenna on the transmitter for wireless charging, converting the second alternating-current electric signal into a radio frequency signal for wireless charging and transmitting the radio frequency signal.

13. The method of claim 12, wherein converting the first alternating-current electric signal into the second alternating-current electric signal of the second frequency comprises:
converting the first alternating-current electric signal into a first direct-current electric signal;
performing smoothing processing on the first direct-current electric signal to obtain a second direct-current electric signal; and
performing frequency modulation on the second direct-current electric signal to convert the second direct-current electric signal into the second alternating-current electric signal of the second frequency.

14. The method of claim 12, further comprising:
detecting whether there is a living body entering a preset range of the transmitter for wireless charging and forming a detection signal; and
when the detection signal indicates that there is a living body entering the preset range, reducing transmission power of the radio frequency signal.

15. The method of claim 12, further comprising:
displaying a charging parameter for wireless charging through a display screen on the transmitter for wireless charging, the charging parameter comprising at least one of:
the second frequency;
a charging current;
a charging voltage; and
charging power.

16. A method for wireless charging, applied to the terminal of claim 8, the method comprising:
receiving the radio frequency signal for wireless charging based on the at least one second radio frequency antenna;
converting the radio frequency signal into the third direct-current electric signal of the third frequency; and
charging the terminal based on the third direct-current electric signal.

17. The method of claim 16, wherein converting the radio frequency signal into the third direct-current electric signal of the third frequency comprises:
converting the radio frequency signal into a fourth direct-current electric signal; and
performing smoothing processing on the fourth direct-current electric signal to obtain the third direct-current electric signal of the third frequency.

18. A non-transitory computer-readable storage medium, having instructions stored thereon that, when executed by the transmitter of claim 1, cause the transmitter to execute a method comprising:
receiving the first alternating-current electric signal of the first frequency;
converting the first alternating-current electric signal into the second alternating-current electric signal of the second frequency; and
based on the at least one first radio frequency antenna, converting the second alternating-current electric signal into the radio frequency signal for wireless charging, and transmitting the radio frequency signal.

19. A non-transitory computer-readable storage medium, having instructions stored thereon that, when executed by the terminal of claim 8, cause the terminal to execute a method comprising:
receiving the radio frequency signal for wireless charging based on the at least one second radio frequency antenna;
converting the radio frequency signal into the third direct-current electric signal of the third frequency; and
charging the terminal based on the third direct-current electric signal.

20. A terminal device implementing the method of claim 16, wherein the terminal device comprises a display screen configured to display a charging parameter to be viewable by a user, the charging parameter comprising at least one of:
a second frequency, a charging current, a charging voltage, and charging power.
